(19) United States
(12) Patent Application Publication
(10) Pub. No.: US 2021/0012644 A1
(43) Pub. Date: Jan. 14, 2021

(54) INFORMATION PROCESSING DEVICE, INFORMATION PROCESSING METHOD, AND INFORMATION PROCESSING PROGRAM

(71) Applicant: TOYOTA JIDOSHA KABUSHIKI KAISHA, Toyota-shi (JP)

(72) Inventors: Akira SASAKI, Miyoshi-shi (JP); Jun HIOKI, Nagakute-shi (JP); Kazuki MATSUMOTO, Oogaki-shi (JP); Fumio WADA, Nagoya-shi (JP)

(73) Assignee: TOYOTA JIDOSHA KABUSHIKI KAISHA, Toyota-shi (JP)

(21) Appl. No.: 16/847,790

(22) Filed: Apr. 14, 2020

(30) Foreign Application Priority Data
Jul. 10, 2019 (JP) 2019-128794

(51) Int. Cl. G08B 25/01; H04W 4/029; H04W 4/46; H04W 4/90; H04W 76/50

(52) U.S. Cl. CPC G08B 25/016; H04W 4/029; H04W 76/50; H04W 4/90; H04W 4/46

(57) ABSTRACT

An information processing device includes a controller configured to execute acquiring a position of a reporting vehicle that is a vehicle having reported occurrence of an emergency, acquiring a position of an emergency vehicle that is a vehicle to be dispatched to an occurrence site of the emergency to respond to the emergency, specifying, based on the position of the reporting vehicle and the position of the emergency vehicle, a base station that relays radio waves of wireless communication to be performed between the vehicles, and controlling the base station such that directivity of a radio wave from the base station toward the reporting vehicle and directivity of a radio wave from the base station toward the emergency vehicle are enhanced.

### INCORPORATION BY REFERENCE

The disclosure of Japanese Patent Application No. 2019-128794 filed on Jul. 10, 2019 including the specification, drawings and abstract is incorporated herein by reference in its entirety.

### BACKGROUND

### 1. Technical Field

The present disclosure relates to an information processing device, an information processing method, and an information processing program.

### 2. Description of Related Art

In recent years, communication techniques for a vehicle, such as Vehicle-to-Everything (V2X), have been developed. Accordingly, vehicles in which equipment capable of performing communication with external equipment is mounted have also been developed. With a vehicle in which such equipment is mounted, for example, when an emergency, such as an accident, occurs, it is possible to make a report (emergency report) to an emergency response agency, such as a fire department or a police agency (for example, see Japanese Unexamined Patent Application Publication No. 2016-024710 (JP 2016-024710 A)).

### SUMMARY

Incidentally, in a process in which a person in charge (for example, a firefighter, a rescuer, a police officer, or the like) of the emergency response agency moves to an emergency occurrence site by an emergency vehicle, acquisition of information using wireless communication is also significant. For example, during the movement of the emergency vehicle, in a case where high-quality wireless communication can be stably performed between the emergency vehicle and a reporting vehicle (a vehicle that is a source of the emergency report), the person in charge can more accurately ascertain the details (a state of an occupant, a status of the vehicle, and the like) of the emergency, and the person in charge can instruct the occupant or the like of the reporting vehicle how to perform more accurate first-aid treatment, or the like.

However, the emergency vehicle or the reporting vehicle is not always positioned in an area where wireless communication of a large-capacity and high-speed communication system can be used. For example, in a case where a traveling route of the emergency vehicle deviates from the above-described area, the quality of wireless communication to be performed between the emergency vehicle and the reporting vehicle may be degraded. As a result, during the movement of the emergency vehicle, there is a possibility that acquisition of information using wireless communication is not suitably performed.

The disclosure provides a technique effective in securing the quality of wireless communication to be performed between a reporting vehicle and an emergency vehicle.

A first aspect of the disclosure relates to an information processing device. The information processing device includes a controller. The controller is configured to execute acquiring a position of a reporting vehicle that is a vehicle having reported occurrence of an emergency, acquiring a position of an emergency vehicle that is a vehicle to be dispatched to an occurrence site of the emergency to respond to the emergency, specifying, based on the position of the reporting vehicle and the position of the emergency vehicle, a base station that relays radio waves of wireless communication to be performed between the reporting vehicle and the emergency vehicle, and controlling the base station such that directivity of a radio wave from the base station toward the reporting vehicle and directivity of a radio wave from the base station toward the emergency vehicle are enhanced.

A second aspect of the disclosure relates to an information processing method that is executed by a computer. In the information processing method, for example, a computer may execute a step of acquiring a position of a reporting vehicle that is a vehicle having reported occurrence of an emergency, a step of acquiring a position of an emergency vehicle that is a vehicle to be dispatched to an occurrence site of the emergency to respond to the emergency, a step of specifying, based on the position of the reporting vehicle and the position of the emergency vehicle, a base station that relays radio waves of wireless communication to be performed between the reporting vehicle and the emergency vehicle, and a step of controlling the base station such that directivity of a radio wave from the base station toward the reporting vehicle and directivity of a radio wave from the base station toward the emergency vehicle are enhanced.

A third aspect of the disclosure relates to an information processing program that is executed by a computer or a non-transitory storage medium that stores such an information processing program. The information processing program may cause, for example, a computer to execute a step of acquiring a position of a reporting vehicle that is a vehicle having reported occurrence of an emergency, a step of acquiring a position of an emergency vehicle that is a vehicle to be dispatched to an occurrence site of the emergency to respond to the emergency, a step of specifying, based on the position of the reporting vehicle and the position of the emergency vehicle, a base station that relays radio waves of wireless communication to be performed between the reporting vehicle and the emergency vehicle, and a step of controlling the base station such that directivity of a radio wave from the base station toward the reporting vehicle and directivity of a radio wave from the base station toward the emergency vehicle are enhanced.

According to the aspects of the disclosure, it is possible to provide a technique effective in securing the quality of wireless communication to be performed between a reporting vehicle and an emergency vehicle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating the outline of a vehicle communication management system;

FIG. 2 is a diagram showing a hardware configuration example of each of a first in-vehicle device, a second in-vehicle device, a server device, and a base station in an embodiment;

FIG. 3 is a block diagram showing the functional configuration of the server device;

FIG. 4 is a diagram showing a configuration example of a positional information table;

FIG. 5 is a diagram showing an example of map information for identifying an area where each base station can perform wireless communication;

FIG. 6 is a flowchart showing a processing flow that is executed by the server device in the embodiment;

FIG. 7 is a diagram showing a hardware configuration example of each of a first in-vehicle device, a second in-vehicle device, a server device, and a base station in a modification example; and

FIG. 8 is a flowchart showing a processing flow that is executed by the server device in the modification example.

### DETAILED DESCRIPTION OF EMBODIMENTS

The disclosure relates to an information processing device that, when a report (emergency report) for notifying of the occurrence of an emergency, such as an accident, occurs, manages wireless communication to be performed between a vehicle (reporting vehicle) as a source of the emergency report and an emergency vehicle to be dispatched to an occurrence site of the emergency.

Here, in an emergency vehicle that travels on a road to respond to an emergency, such as a first-aid vehicle, a firefighting vehicle, or a police vehicle, in a case where the details (a state of a person to be rescued, a situation of damage to a destination, and the like) of the emergency can be ascertained in advance, it is possible to quickly and accurately perform rescue activities and the like. For this reason, during the movement of the emergency vehicle, it is significant to secure the quality of wireless communication to be performed between the reporting vehicle and the emergency vehicle.

However, the reporting vehicle or the emergency vehicle is not always positioned in an area where wireless communication of a large-capacity and high-speed communication system can be used. In a case where the position of the reporting vehicle or the emergency vehicle deviates from the above-described area, the quality of wireless communication to be performed between the reporting vehicle and the emergency vehicle may be degraded. Even though the position of the reporting vehicle or the emergency vehicle is within the above-described area, when a communication system that is provided within the area is a communication system in which the use of a high-frequency band is assumed, such as 5th-Generation (5G), since radio waves of wireless communication are likely to be attenuated, wireless communication to be performed between the reporting vehicle and the emergency vehicle may be unstable. As a result, a case where acquisition of information is not suitably performed during the movement of the emergency vehicle may occur.

In contrast, in the information processing device according to an embodiment of the disclosure, a controller acquires a position of the reporting vehicle and a position of the emergency vehicle. Subsequently, the controller specifies, based on the position of the reporting vehicle and the position of the emergency vehicle, a base station that relays the radio waves of wireless communication to be performed between the vehicles. Then, for the specified base station, the controller controls the base station such that the directivity of a radio wave from the base station toward the reporting vehicle and the directivity of a radio wave from the base station toward the emergency vehicle are enhanced. A case where a base station that performs communication with the reporting vehicle and a base station that performs communication with the emergency vehicle are different may be assumed. In this case, it should suffice that control is performed on the base station that performs communication with the reporting vehicle such that the directivity of the radio wave from the base station toward the reporting vehicle is enhanced. Then, it should suffice that control is performed on the base station that performs communication with the emergency vehicle such that the directivity of the radio wave from the base station toward the emergency vehicle is enhanced.

With the information processing device according to the embodiment of the disclosure, it is possible to increase reception intensity when the reporting vehicle receives the radio wave from the base station, and to increase reception intensity when the emergency vehicle receives the radio wave from the base station. With this, it is possible to secure the quality of wireless communication to be performed between the reporting vehicle and the emergency vehicle. As a result, during the movement of the emergency vehicle, it is possible to perform high-quality and stable wireless communication between the emergency vehicle and the reporting vehicle.

Here, when the reporting vehicle includes a camera that images at least one of a vehicle inside and a vehicle outside, the controller may transmit, to the reporting vehicle, a command for transmitting image data captured by the camera to the emergency vehicle. In a case where the quality of wireless communication to be performed between the reporting vehicle and the emergency vehicle is secured in the above-described manner, it is possible to transmit a large amount of data from the reporting vehicle toward the emergency vehicle. Accordingly, it is possible to more reliably transmit a large amount of data, such as a moving image, captured by the camera of the reporting vehicle from the reporting vehicle to the emergency vehicle. Then, in a case where image data captured by the camera of the reporting vehicle can be received by the emergency vehicle, it is possible to allow a person in charge of the emergency vehicle to more accurately ascertain the details of the emergency. In addition, it is possible to allow the person in charge to instruct an occupant or the like of the reporting vehicle how to perform more accurate first-aid treatment, or the like.

Hereinafter, a specific embodiment of the disclosure will be described referring to the drawings. The dimensions, materials, shapes, relative arrangements, and the like of components described in the embodiment are not intended to limit the scope of the disclosure to these alone in particular as long as there are no specific statements.

### Embodiment

In the embodiment, an example where the disclosure is applied to a system (hereinafter, also referred to as a “vehicle communication management system”) that manages communication to be performed between vehicles when an emergency occurs will be described. Vehicles to be managed by the vehicle communication management system include emergency vehicles (for example, vehicles for first-aid (first-aid vehicles), vehicles for firefighting (firefighting vehicles), vehicles for police (police vehicles), and the like)), and reporting vehicles (non-emergency vehicles, such as passenger vehicles or commercial vehicles, and vehicles that are sources of emergency reports).

Outline of Vehicle Communication Management System

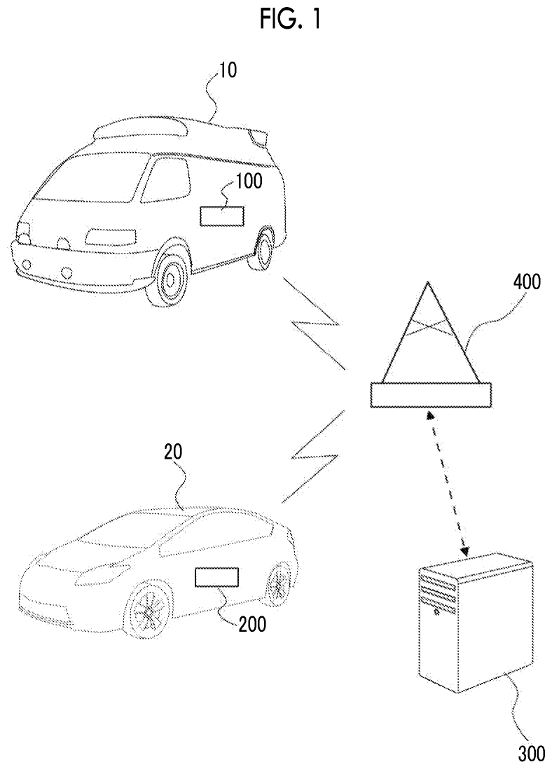

FIG. 1 is a diagram showing the schematic configuration of the vehicle communication management system. The vehicle communication management system in the embodiment includes an in-vehicle device 100 (hereinafter, referred to as a “first in-vehicle device 100”) that is mounted in an emergency vehicle 10, an in-vehicle device 200 (hereinafter, referred to as a “second in-vehicle device 200”) that is mounted in a reporting vehicle 20, a server device 300, and a base station 400. In the example shown in FIG. 1, although solely one emergency vehicle 10, solely one reporting vehicle 20, and solely one base station 400 are shown, a plurality of emergency vehicles 10, reporting vehicles 20, and base stations 400 may be provided. The first in-vehicle device 100 and the second in-vehicle device 200 are connected to the base station 400 using wireless communication to be able to be connected to a network through the base station 400. The term “wireless communication” used herein refers to, for example, mobile communication, such as 5G or Long Term Evolution (LTE), narrowband communication, such as Dedicated Short Range Communications (DSRC), Wi-Fi (Registered Trademark), or the like. The server device 300 and the base station 400 can be connected to the network using wired communication or wireless communication. The term “network” used herein refers to, for example, a wide area network (WAN) that is a worldwide public communication network, such as the Internet, other communication networks, or the like.

The first in-vehicle device 100 acquires a current position of the emergency vehicle 10. Then, the first in-vehicle device 100 transmits information (positional information) including information indicating the current position of the emergency vehicle 10 and identification information of the emergency vehicle 10 to the server device 300. The acquisition of the current position and the transmission of the positional information in the first in-vehicle device 100 are repeatedly performed in a predetermined cycle.

The second in-vehicle device 200 performs an emergency report to a report reception center or the like of an emergency response agency (for example, a fire department, a police agency, or the like) when an emergency report operation is performed by an occupant of the reporting vehicle 20, when an accident or the like of the reporting vehicle 20 is detected, or the like. The second in-vehicle device 200 acquires a current position of the reporting vehicle 20 and transmits positional information including information indicating the acquired current position and identification information of the reporting vehicle 20 to the server device 300. The acquisition of the current position and the transmission of the positional information in the second in-vehicle device 200 are repeatedly performed in a predetermined cycle.

The server device 300 is provided in the report reception center of the emergency response agency, an affiliated agency of the emergency response agency, or the like, and performs processing (hereinafter, referred to as “communication management processing”) for making high-quality and stable wireless communication be performed between the emergency vehicle 10 (first in-vehicle device 100) and the reporting vehicle 20 (second in-vehicle device 200). In the communication management processing of the example, the server device 300 transmits a beam forming command to the base station 400 that relays radio waves of wireless communication to be performed between the emergency vehicle 10 and the reporting vehicle 20. The beam forming command is a command for making each of the emergency vehicle 10 and the reporting vehicle 20 perform beam forming.

The base station 400 relays the radio waves of wireless communication to be performed between the reporting vehicle 20 and the emergency vehicle 10. The base station 400 in the example has a function of performing beam forming on a specific communication terminal existing in an area where the radio waves from the base station 400 reach. For example, the base station 400 performs beam forming on the reporting vehicle 20 and beam forming on the emergency vehicle 10 according to the beam forming command from the server device 300.

Hardware Configuration

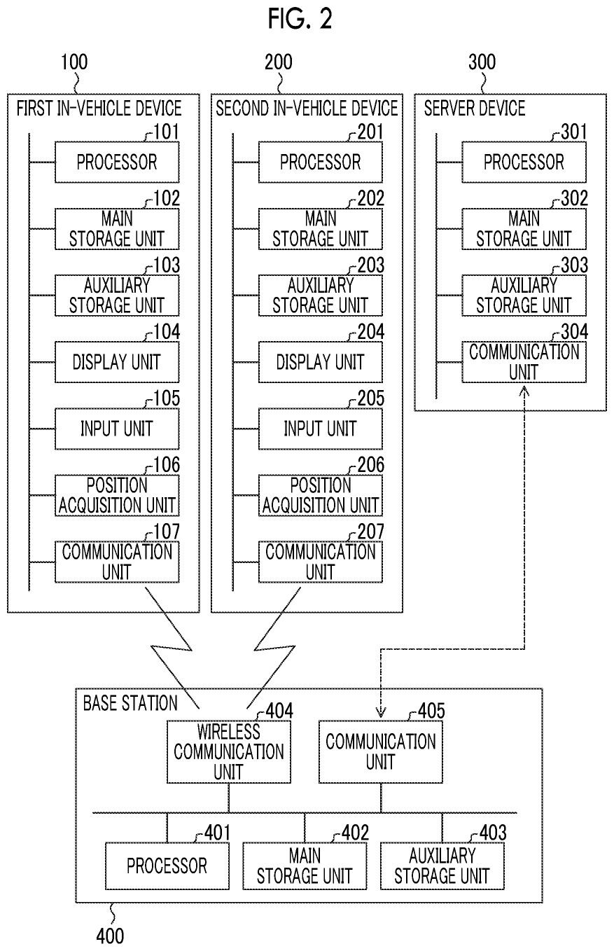

FIG. 2 is a diagram showing an example of the hardware configuration of each of the first in-vehicle device 100, the second in-vehicle device 200, the server device 300, and the base station 400.

The server device 300 has the configuration of a general computer. That is, the server device 300 has a processor 301, a main storage unit 302, an auxiliary storage unit 303, and a communication unit 304. The units are connected to one another by a bus. The main storage unit 302 and the auxiliary storage unit 303 are computer-readable recording mediums. The hardware configuration of the computer is not limited to the example shown in FIG. 2, and components may be appropriately omitted, substituted, and added.

In the server device 300, the processor 301 loads a program stored in a recording medium into a work area of the main storage unit 302 and executes the program, and respective functional constituent units and the like are controlled with the execution of the program, whereby a function conforming to a predetermined purpose is implemented.

The processor 301 is, for example, a central processing unit (CPU) or a digital signal processor (DSP). The processor 301 performs control to the server device 300 and performs arithmetic operations of various kinds of information processing. The main storage unit 302 includes, for example, a random access memory (RAM) or a read only memory (ROM). The auxiliary storage unit 303 is, for example, an erasable programmable ROM (EPROM) or a hard disk drive (HDD). The auxiliary storage unit 303 can include a removable medium, that is, a portable recording medium. The removable medium is, for example, a universal serial bus (USB) memory or a disc recording medium, such as a compact disc (CD) or a digital versatile disc (DVD).

The auxiliary storage unit 303 stores various programs, various kinds of data, and various tables in a recording medium in a readable and writable manner. In the auxiliary storage unit 303, an operating system (OS), various programs, various tables, and the like are stored. A part or all of the above-described information may be stored in the main storage unit 302. Information that is stored in the main storage unit 302 may be stored in the auxiliary storage unit 303.

The communication unit 304 performs transmission and reception of information between an external device and the server device 300. The communication unit 304 is, for example, a local area network (LAN) interface board or a wireless communication circuit for wireless communication. The LAN interface board or the wireless communication circuit is connected to the network.

A series of processing that is executed by the server device 300 configured as described above can be executed by hardware, but can also be executed by software.

Next, the first in-vehicle device 100 is, for example, a car navigation system that can be connected to the network using wireless communication. The first in-vehicle device 100 may be a personal computer (PC) that is connected to the network using wireless communication. The first in-vehicle device 100 may be, for example, a small computer that can be carried with the person in charge who boards the emergency vehicle 10, such as a smartphone, a mobile phone, a tablet terminal, a personal digital assistant, or a wearable computer (a smart watch or the like).

As shown in FIG. 2, the first in-vehicle device 100 has a processor 101, a main storage unit 102, an auxiliary storage unit 103, a display unit 104, an input unit 105, a position acquisition unit 106, and a communication unit 107. The processor 101, the main storage unit 102, and the auxiliary storage unit 103 are the same as the processor 301, the main storage unit 302, and the auxiliary storage unit 303 of the server device 300, and thus, description thereof will not be repeated. The display unit 104 is, for example, a liquid crystal display (LCD), an electroluminescence (EL) panel, or the like. The input unit 105 includes, for example, a touch panel or push buttons capable of inputting symbols, such as characters, a microphone capable of inputting voice, and the like. The position acquisition unit 106 is equipment that acquires a current position of the first in-vehicle device 100 (the current position of the emergency vehicle 10), and typically includes a GPS receiver and the like. The communication unit 107 is, for example, a communication circuit that accesses the network using wireless communication, such as a mobile communication service, and performs data communication with external equipment, such as the second in-vehicle device 200 or the server device 300.

The second in-vehicle device 200 is, for example, a car navigation system that is mounted in the reporting vehicle 20 and can be connected to the network using wireless communication. The second in-vehicle device 200 may be a personal computer that is connected to the network using wireless communication. The second in-vehicle device 200 may be, for example, a small computer that can be carried with the occupant of the reporting vehicle 20, such as a smartphone, a mobile phone, a tablet terminal, a personal digital assistant, or a wearable computer (a smart watch or the like).

As shown in FIG. 2, the second in-vehicle device 200 has a processor 201, a main storage unit 202, an auxiliary storage unit 203, a display unit 204, an input unit 205, a position acquisition unit 206, and a communication unit 207. The processor 201, the main storage unit 202, the auxiliary storage unit 203, the display unit 204, the position acquisition unit 206, and the communication unit 207 are the same as the processor 101, the main storage unit 102, the auxiliary storage unit 103, the display unit 104, the position acquisition unit 106, and the communication unit 107 of the first in-vehicle device 100, and thus, description thereof will not be repeated. The input unit 205 has a reporting unit, such as an emergency report button, which is operated when the occupant makes an emergency report, in addition to a touch panel or push buttons capable of inputting symbols, such as characters, a microphone capable of inputting voice, and the like.

The base station 400 has a processor 401, a main storage unit 402, an auxiliary storage unit 403, a wireless communication unit 404, and a communication unit 405. The processor 401, the main storage unit 402, the auxiliary storage unit 403, and the communication unit 405 are the same as the processor 301, the main storage unit 302, the auxiliary storage unit 303, and the communication unit 304 of the server device 300, and thus, description thereof will not be repeated. The wireless communication unit 404 performs wireless communication with the first in-vehicle device 100 or the second in-vehicle device 200. The wireless communication unit 404 of the example also has a function of performing beam forming. Beam forming is a technique for generally improving the directivity of radio waves toward a specific reception position. As a method of implementing beam forming, a known method can be used. As an example, a method that uses a transmission antenna having a plurality of antenna elements, and relatively shifts the phase and amplitude of a radio wave transmitted from each antenna element such that the radio waves transmitted from the antenna elements are reinforced one another at a specific reception angle and the radio waves are cancelled one another at other reception angles can be used.

Functional Configuration of Server Device

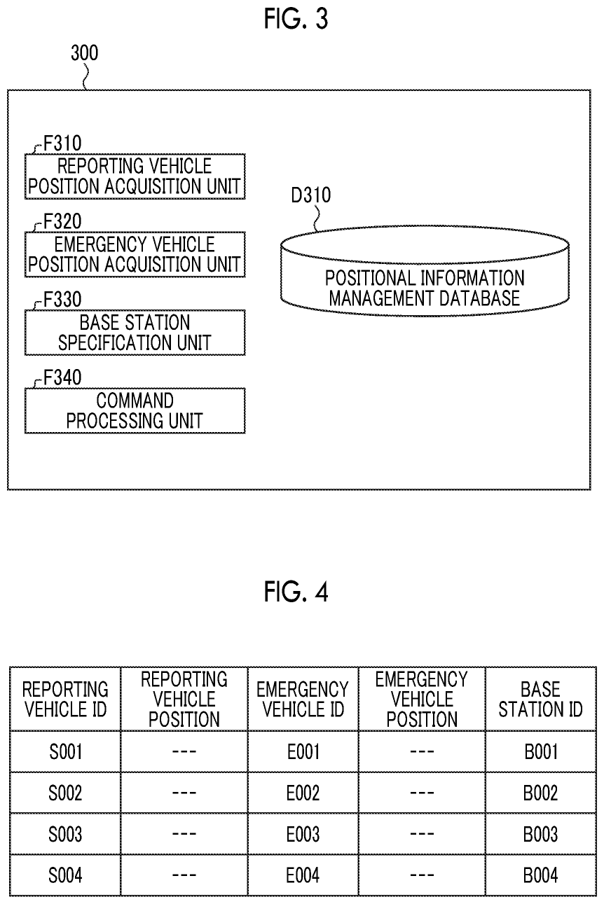

Here, the functional configuration of the server device 300 will be described referring to FIG. 3. As shown in FIG. 3, the server device 300 of the embodiment includes, as functional components, a reporting vehicle position acquisition unit F310, an emergency vehicle position acquisition unit F320, a base station specification unit F330, a command processing unit F340, and a positional information management database D310. Here, the reporting vehicle position acquisition unit F310, the emergency vehicle position acquisition unit F320, the base station specification unit F330, and the command processing unit F340 are formed by the processor 301 of the server device 300 executing a computer program on the main storage unit 302. Any one or a part of the reporting vehicle position acquisition unit F310, the emergency vehicle position acquisition unit F320, the base station specification unit F330, and the command processing unit F340 may be formed by a hardware circuit. The positional information management database D310 is constructed by a program of a database management system (DBMS) to be executed by the processor 301 of the server device 300 managing data stored in the auxiliary storage unit 303. Such a positional information management database D310 is, for example, a relational database.

Any one of the functional components of the server device 300 or a part of the processing may be executed by another computer connected to the server device 300 through the network. For example, each kind of processing included in the reporting vehicle position acquisition unit F310, each kind of processing included in the emergency vehicle position acquisition unit F320, each kind of processing included in the base station specification unit F330, and each kind of processing included in the command processing unit F340 may be executed by separate computers.

In the positional information management database D310, the current position of the reporting vehicle 20, the current position of the emergency vehicle 10 to be dispatched to the emergency occurrence site notified by the emergency report from the reporting vehicle 20, and the base station 400 that relays the radio waves of wireless communication to be performed between the vehicles are associated with one another. Here, one configuration example of information stored in the positional information management database D310 will be described referring to FIG. 4. FIG. 4 is a diagram showing the table configuration of information stored in the positional information management database D310. The configuration of a table (hereinafter, also referred to as a “positional information table”) stored in the positional information management database D310 is not limited to the example shown in FIG. 4, and fields may be appropriately added, changed, and deleted.

The positional information table shown in FIG. 4 has respective fields of reporting vehicle ID, reporting vehicle position, emergency vehicle ID, emergency vehicle position, base station ID, and the like. In the reporting vehicle ID field, the identification information of the reporting vehicle 20 that is the source of the emergency report is registered. In the reporting vehicle position field, information indicating the current position of each reporting vehicle 20 is registered. In the emergency vehicle ID field, the identification information of the emergency vehicle 10 (the emergency vehicle 10 to be dispatched to the emergency occurrence site notified by the emergency report from each reporting vehicle 20) associated with each reporting vehicle 20 is registered. In the emergency vehicle position field, information indicating the current position of each emergency vehicle 10 is registered. In the base station ID field, in each combination of the reporting vehicle 20 and the emergency vehicle 10, identification information of the base station 400 that relays the radio waves of wireless communication to be performed between the reporting vehicle 20 and the emergency vehicle 10 is registered. When a base station that performs communication with the reporting vehicle 20 and a base station that performs communication with the emergency vehicle 10 are different, the identification information of a plurality of base stations may be registered in the base station ID field. In such a positional information table, information to be registered in the reporting vehicle position field and the emergency vehicle position field may be, for example, information indicating an address of a place where each vehicle is positioned or may be information indicating coordinates (latitude and longitude) of a place where each vehicle is positioned on a map. Then, it is assumed that information to be input in the reporting vehicle position field and the emergency vehicle position field is updated each time the server device 300 receives the positional information transmitted from each vehicle in each predetermined cycle. Since the base station 400 that relays the radio waves of wireless communication to be performed between the reporting vehicle 20 and the emergency vehicle 10 may be changed according to the position of the reporting vehicle 20 or the position of the emergency vehicle 10, information to be registered in the base station ID field is also updated each time information of the reporting vehicle position field and the emergency vehicle position field is updated.

The reporting vehicle position acquisition unit F310 acquires the current position of the reporting vehicle 20. For example, the reporting vehicle position acquisition unit F310 receives the positional information transmitted from the second in-vehicle device 200 in each predetermined cycle through the communication unit 304 to acquire the current position of the reporting vehicle 20. The current position of the reporting vehicle 20 acquired in such a manner is registered in the reporting vehicle position field of the positional information table corresponding to the identification information (the identification information included in the positional information from the second in-vehicle device 200) of the reporting vehicle 20.

The emergency vehicle position acquisition unit F320 acquires the current position of the emergency vehicle 10. For example, the emergency vehicle position acquisition unit F320 receives the positional information transmitted from the first in-vehicle device 100 in each predetermined cycle through the communication unit 304, thereby acquiring the current position of the emergency vehicle 10. The current position of the emergency vehicle 10 acquired in such a manner is registered in the emergency vehicle position field of the positional information table corresponding to the identification information (the identification information included in the positional information from the first in-vehicle device 100) of the emergency vehicle 10.

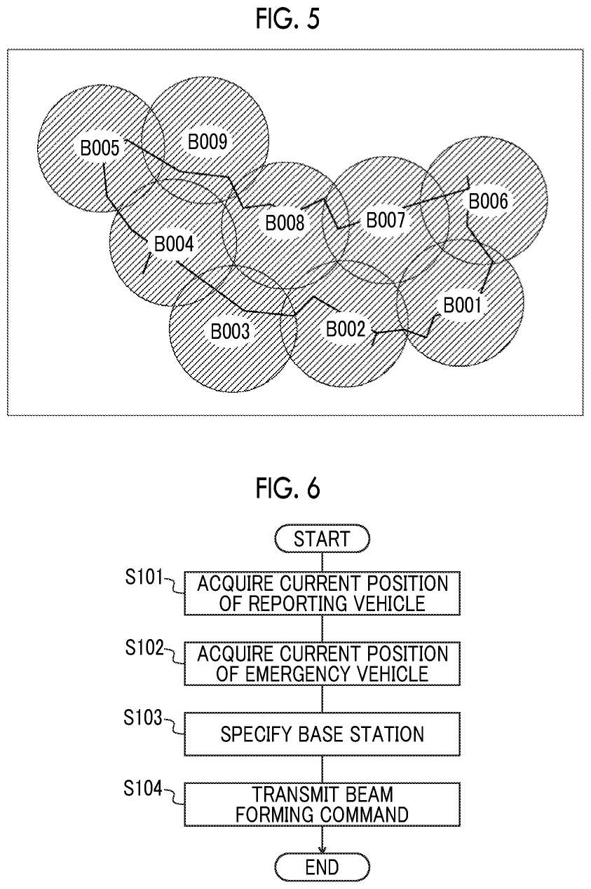

The base station specification unit F330 specifies the base station 400 that relays the radio waves of wireless communication between the reporting vehicle 20 (second in-vehicle device 200) and the emergency vehicle 10 (first in-vehicle device 100). The specification of the base station is performed, for example, by collating the current positions of the reporting vehicle 20 and the emergency vehicle 10 with map information shown in FIG. 5. FIG. 5 is a diagram showing an example of map information for identifying an area where each base station 400 can perform wireless communication. In FIG. 5, hatched portions indicate areas where each base station 400 can perform wireless communication. In FIG. 5, character information (B001 to B009) attached to the hatched portions indicate the identification information of the base stations 400 disposed in the respective areas. The base station specification unit F330 specifies an area, to which the current positions of the reporting vehicle 20 and the emergency vehicle 10 belong, with reference to the map information shown in FIG. 5 and extracts the identification information of the base station 400 disposed in the area. When an area to which the current position of the reporting vehicle 20 belongs and an area to which the current position of the emergency vehicle 10 belongs are different, the base station specification unit F330 extracts the identification information of the base stations 400 disposed in the respective areas. The identification information of the base station 400 extracted in such a manner is registered in the base station ID field of the positional information table corresponding to the combination of the reporting vehicle 20 and the emergency vehicle 10.

The command processing unit F340 transmits a beam forming command to the base station 400, which relays the radio waves of wireless communication to be performed between the reporting vehicle 20 and the emergency vehicle 10, through the communication unit 304. The beam forming command in the example is formed to include information indicating the current position of the reporting vehicle 20 and information indicating the current position of the emergency vehicle 10. In the base station 400 that receives such a beam forming command, beam forming toward the current position of the reporting vehicle 20 and beam forming toward the current position of the emergency vehicle 10 are performed.

Flow of Processing

Next, a flow of communication management processing that is executed by the server device 300 in the embodiment will be described referring to FIG. 6. FIG. 6 is a flowchart showing a processing flow that is repeatedly executed in each predetermined cycle in the server device 300.

In the processing flow of FIG. 6, the reporting vehicle position acquisition unit F310 of the server device 300 acquires the current position of the reporting vehicle 20 (Step S101). Specifically, as described above, the reporting vehicle position acquisition unit F310 receives the positional information transmitted from the second in-vehicle device 200 of the reporting vehicle 20 in each predetermined cycle through the communication unit 304 to acquire the current position of the reporting vehicle 20. Then, the reporting vehicle position acquisition unit F310 accesses the positional information management database D310 based on the identification information of the reporting vehicle 20 included in the positional information to update information registered in the reporting vehicle position field of the positional information table corresponding to the identification information to information acquired in Step S101.

The emergency vehicle position acquisition unit F320 of the server device 300 acquires the current position of the emergency vehicle 10 (Step S102). Specifically, as described above, the emergency vehicle position acquisition unit F320 receives the positional information transmitted from the first in-vehicle device 100 of the emergency vehicle 10 in each predetermined cycle through the communication unit 304, thereby acquiring the current position of the emergency vehicle 10. Then, the emergency vehicle position acquisition unit F320 accesses the positional information management database D310 based on the identification information of the emergency vehicle 10 included in the positional information to update information registered in the emergency vehicle position field of the positional information table corresponding to the identification information to information acquired in Step S102.

An execution order of Steps S101 and S102 is not limited to the example shown in FIG. 6, and when a timing of receiving the positional information from the first in-vehicle device 100 is earlier than a timing of receiving the positional information from the second in-vehicle device 200, the processing of Step S102 may be executed before the processing of Step S101.

In a case where the current position of the reporting vehicle 20 and the current position of the emergency vehicle 10 are specified, the base station specification unit F330 of the server device 300 specifies the base station 400 that relays the radio waves of wireless communication to be performed between the vehicles (Step S103). Specifically, the base station specification unit F330 collates the current positions of the reporting vehicle 20 and the emergency vehicle 10 with the map information shown in FIG. 5 described above to extract the identification information of the base station 400 disposed in the area to which the current positions of the reporting vehicle 20 and the emergency vehicle 10 belong. Then, the base station specification unit F330 accesses the positional information management database D310 based on the identification information of the reporting vehicle 20 and the emergency vehicle 10, thereby updating information registered in the base station ID field of the positional information table corresponding to the identification information to the identification information of the base station 400 specified in Step S103.

In a case where the current position of the reporting vehicle 20, the current position of the emergency vehicle 10, and the base station 400 are specified, the command processing unit F340 of the server device 300 transmits a beam forming command including current positional information of the reporting vehicle 20 and current positional information of the emergency vehicle 10 to the base station 400 specified in Step S103 (Step S104).

With the processing flow of FIG. 6, the base station 400 that receives the beam forming command from the server device 300 can perform beam forming toward the current position of the reporting vehicle 20 and can perform beam forming toward the current position of the emergency vehicle 10. In this case, the directivity of the radio wave from the base station 400 toward the reporting vehicle 20 is enhanced, and the directivity of the radio wave from the base station 400 toward the emergency vehicle 10 is enhanced. In this case, reception intensity when the second in-vehicle device 200 of the reporting vehicle 20 receives the radio wave from the base station 400 is increased, and reception intensity when the first in-vehicle device 100 of the emergency vehicle 10 receives the radio wave from the base station 400 is increased. With this, even during the movement of at least one of the reporting vehicle 20 and the emergency vehicle 10, it is possible to perform high-quality and stable wireless communication between the vehicles.

Therefore, according to the embodiment, even in the emergency vehicle 10 that is moving, it is possible to more reliably acquire information from the reporting vehicle 20. For this reason, it is possible to allow the person in charge of the emergency vehicle 10 to ascertain the details of the emergency before the emergency vehicle 10 arrives at the emergency occurrence site. As a result, it is possible to allow the person in charge to perform quick and accurate rescue activities and the like when the emergency vehicle 10 arrives at the emergency occurrence site. In addition, it is possible to allow the person in charge to instruct the occupant or the like of the reporting vehicle 20 how to perform first-aid treatment, or the like before the emergency vehicle 10 arrives at the emergency occurrence site.

### Modification Example

Next, a modification example of the above-described embodiment will be described. In the modification example, detailed description of the substantially same configurations and the substantially same control processing as those in the above-described embodiment will not be repeated.

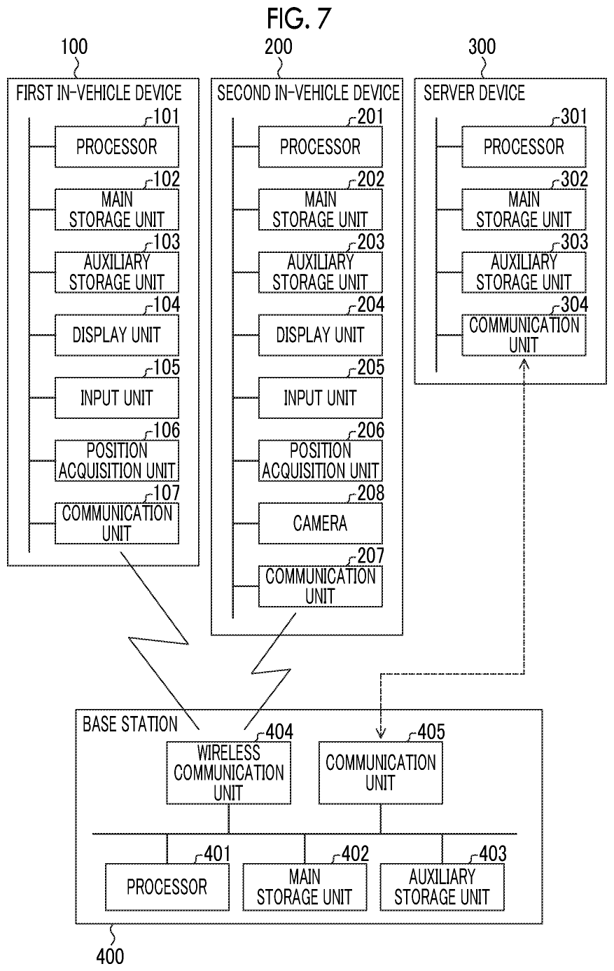

FIG. 7 is a diagram showing the hardware configuration of each of a first in-vehicle device 100, a second in-vehicle device 200, a server device 300, and a base station 400 in the modification example. As shown in FIG. 7, the first in-vehicle device 100, the server device 300, and the base station 400 are the same as those in the above-described embodiment, and thus, description thereof will not be repeated.

The second in-vehicle device 200 in the modification example has a camera 208, in addition to the processor 201, the main storage unit 202, the auxiliary storage unit 203, the display unit 204, the input unit 205, the position acquisition unit 206, and the communication unit 207. The processor 201, the main storage unit 202, the auxiliary storage unit 203, the display unit 204, the input unit 205, the position acquisition unit 206, and the communication unit 207 are the same as those in the above-described embodiment, and thus, description thereof will not be repeated.

The camera 208 is imaging equipment that images at least one of the inside of the reporting vehicle 20 and the outside of the reporting vehicle 20 (around the reporting vehicle 20). The camera 208 may capture a moving image or may capture a still image. The camera 208 is controlled by the processor 201 that executes a computer program on the main storage unit 202. For example, the camera 208 is operated in an operation state (for example, a state in which an ignition switch is on) of the reporting vehicle 20 to be able to play a role as a drive recorder, and is operated at the time of parking of the reporting vehicle 20 to be able to play a role as a security camera. In the modification example, the camera 208 is operated at the time of the occurrence of an emergency, such as an accident, to capture an image of the occupant inside the vehicle or an image around the reporting vehicle 20.

Next, the server device 300 in the modification example has a function of performing processing (hereinafter, also referred to as “image management processing”) for transmitting image data captured by the camera 208 from the reporting vehicle 20 to the emergency vehicle 10, in addition to the communication management processing described in the above-described embodiment. In the image management processing, for example, the command processing unit F340 of the server device 300 operates the camera 208 and transmits a command (image transmission command) for transmitting image data captured by the camera 208 to the first in-vehicle device 100 to the second in-vehicle device 200.

Here, in a state in which the communication management processing described in the above-described embodiment is being executed, it is possible to perform high-quality and stable wireless communication between the first in-vehicle device 100 and the second in-vehicle device 200. Thus, in a case where the image transmission command is transmitted from the server device 300 to the second in-vehicle device 200 in such a state, it is possible to more reliably transmit image data captured by the camera 208 from the second in-vehicle device 200 to the first in-vehicle device 100.

Flow of Processing

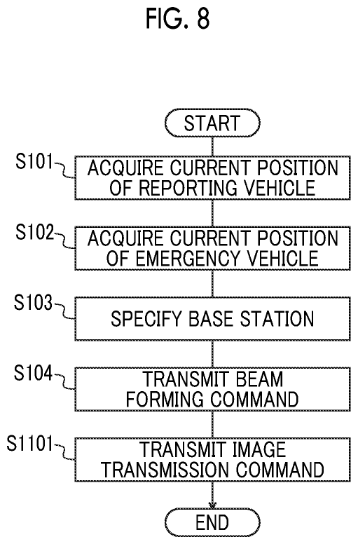

Hereinafter, a flow of the communication management processing and the image management processing that are executed by the server device 300 in the modification example will be described referring to FIG. 8. FIG. 8 is a flowchart showing a processing flow that is repeatedly executed in each predetermined cycle in the server device 300. Processing (communication management processing) of Steps S101 to S104 in FIG. 8 is the same as that in FIG. 6 described above, and thus, description thereof will not be repeated.

In the processing flow of FIG. 8, the command processing unit F340 executes the image management processing after the processing of Step S104 is executed. That is, the command processing unit F340 transmits the image transmission command to the second in-vehicle device 200 of the reporting vehicle 20 (Step S1101). As described above, the image transmission command is a command for operating the camera 208 mounted in the reporting vehicle 20 and transmitting image data captured by the camera 208 to the first in-vehicle device 100 of the emergency vehicle 10.

With the processing flow of FIG. 8, the second in-vehicle device 200 that receives the image transmission command from the server device 300 can operate the camera 208 and can transmit image data captured by the camera 208 toward the first in-vehicle device 100. In this case, since the quality of wireless communication to be performed between the reporting vehicle 20 and the emergency vehicle 10 is secured through the communication management processing, the first in-vehicle device 100 can more reliably receive image data transmitted from the second in-vehicle device 200. With this, it is possible to allow the person in charge of the emergency vehicle 10 to more accurately ascertain the details (the state of the occupant of the reporting vehicle 20, and the like) of the emergency with reference to image data captured by the camera 208. In particular, even though the occupant hardly gives the person in charge the details of the emergency, such as when the occupant of the reporting vehicle 20 is seriously injured, it is possible to allow the person in charge to ascertain the details of the emergency. In addition, it is possible to allow the person in charge to more accurately ascertain the details of the emergency, whereby it is possible to allow the person in charge to instruct the occupant or the like of the reporting vehicle 20 how to perform more accurate first-aid treatment, or the like.

Others

The above-described embodiments are just examples, and the disclosure may be appropriately modified and carried out without departing from the spirit and scope of the disclosure.

The processing or units described in the present disclosure can be freely combined and implemented as long as no technical contradiction arises. Processing described to be executed by one device may be shared and executed by a plurality of devices. Alternatively, processing described to be executed by different devices may be executed by one device. In a computer system, a hardware configuration that implements each function may be flexibly changed.

The disclosure may also be implemented by supplying a computer program mounted with the functions described in the above-described embodiments to a computer and causing one or more processors in the computer to read and execute the program. Such a computer program may be provided to the computer by a non-transitory computer-readable storage medium connectable to a system bus of the computer or may be provided to the computer through a network. The non-transitory computer-readable storage medium is a recording medium that stores information, such as data or programs, by means of electrical, magnetic, optical, mechanical, or chemical action and can be read from a computer or the like, and is, any type of disk, such as a magnetic disk (a Floppy (Registered Trademark) disk, a hard disk drive (HDD), or the like), an optical disc (a CD-ROM, a DVD, a Blu-ray disc, or the like), or a medium, such as a read only memory (ROM), a random access memory (RAM), an EPROM, an EEPROM, a magnetic card, a flash memory, an optical card, or a solid state drive (SSD).

What is claimed is:

1. An information processing device comprising a controller configured to execute
acquiring a position of a reporting vehicle that is a vehicle having reported occurrence of an emergency,
acquiring a position of an emergency vehicle that is a vehicle to be dispatched to an occurrence site of the emergency to respond to the emergency,
specifying, based on the position of the reporting vehicle and the position of the emergency vehicle, a base station that relays radio waves of wireless communication to be performed between the reporting vehicle and the emergency vehicle, and
controlling the base station such that directivity of a radio wave from the base station toward the reporting vehicle and directivity of a radio wave from the base station toward the emergency vehicle are enhanced.

2. The information processing device according to claim 1, wherein, when the reporting vehicle includes a camera configured to image at least one of a vehicle inside and a vehicle outside, the controller transmits, to the reporting vehicle, a command for transmitting image data captured by the camera to the emergency vehicle.

3. An information processing method in which a computer executes:
a step of acquiring a position of a reporting vehicle that is a vehicle having reported occurrence of an emergency;
a step of acquiring a position of an emergency vehicle that is a vehicle to be dispatched to an occurrence site of the emergency to respond to the emergency;
a step of specifying, based on the position of the reporting vehicle and the position of the emergency vehicle, a base station that relays radio waves of wireless communication to be performed between the reporting vehicle and the emergency vehicle; and
a step of controlling the base station such that directivity of a radio wave from the base station toward the reporting vehicle and directivity of a radio wave from the base station toward the emergency vehicle are enhanced.

4. An information processing program causing a computer to execute:
a step of acquiring a position of a reporting vehicle that is a vehicle having reported occurrence of an emergency;
a step of acquiring a position of an emergency vehicle that is a vehicle to be dispatched to an occurrence site of the emergency to respond to the emergency;
a step of specifying, based on the position of the reporting vehicle and the position of the emergency vehicle, a base station that relays radio waves of wireless communication to be performed between the reporting vehicle and the emergency vehicle; and
a step of controlling the base station such that directivity of a radio wave from the base station toward the reporting vehicle and directivity of a radio wave from the base station toward the emergency vehicle are enhanced.
